(19) United States
(12) Patent Application Publication
(10) Pub. No.: US 2025/0201462 A1
(43) Pub. Date: Jun. 19, 2025

(54) INDUCTANCE ADJUSTABLE INDUCTOR AND SIGNAL TRANSMISSION DEVICE INCLUDING THE SAME

(71) Applicant: Global Technology Inc., Ningbo (CN)

(72) Inventors: Hao JIN, Ningbo (CN); Fan YANG, Ningbo (CN); Qikun HUANG, Ningbo (CN)

(21) Appl. No.: 18/657,197

(22) Filed: May 7, 2024

(30) Foreign Application Priority Data
Dec. 18, 2023 (CN) 202311744993.9

(51) Int. Cl. H01F 27/00; H01F 5/04; H01F 21/12; H01F 27/40

(52) U.S. Cl. CPC H01F 27/006; H01F 5/04; H01F 21/12; H01F 27/40

(57) ABSTRACT

An inductor includes a coil and a magnetic core. The coil has a cavity which extends axially, and the magnetic core is disposed through the cavity. The magnetic core includes a first magnetic portion and a second magnetic portion. The first magnetic portion and the second magnetic portion are arranged in an axial direction of the coil, and the first magnetic portion and the second magnetic portion have different radial sizes.

### CROSS-REFERENCE TO RELATED APPLICATIONS

This application claims priority under 35 U.S.C. § 119 (a) on Patent Application No(s). 202311744993.9 filed in China on Dec. 18, 2023, the entire contents of which are hereby incorporated by reference.

### BACKGROUND

### 1. Technical Field

The present disclosure relates to an inductor, more particularly to an inductor with adjustable inductance and a signal transmission device including the same.

### 2. Related Art

With the development of technology, many devices are linked to mobile networks, and new services and applications are emerging one after another. The business service types of bi-directional cable television (CATV) networks are becoming more and more numerous. Due to the explosive growth in network data demand, the present network systems are facing severe challenges. To improve the user experience quality of the network, multiple network channels need to be deployed, which greatly increases the cost of network equipment deployment and maintenance.

### SUMMARY

According to one aspect of the present disclosure, an inductor includes a coil and a magnetic core. The coil has a cavity which extends axially, and the magnetic core is disposed through the cavity. The magnetic core includes a first magnetic portion and a second magnetic portion. The first magnetic portion and the second magnetic portion are arranged in an axial direction of the coil, and the first magnetic portion and the second magnetic portion have different radial sizes.

According to another aspect of the present disclosure, an inductor includes a coil and a magnetic core. The coil has a cavity which extends axially, and the magnetic core is disposed through the cavity. The coil includes a first winding portion and a second winding portion which are arranged axially. The first winding portion is connected to the second winding portion. The first winding portion is wound counterclockwise around the magnetic core, and the second winding portion is wound clockwise around the magnetic core.

According to still another aspect of the present disclosure, an inductor includes a coil and a magnetic core. The coil has a cavity which extends axially, and the magnetic core is disposed through the cavity. The coil includes a first winding portion, a second winding portion and a third winding portion arranged in an axial direction of the coil. The third winding portion is disposed between the first winding portion and the second winding portion. The first winding portion is connected to the second winding portion through the third winding portion. Each of the first winding portion, the second winding portion and the third winding portion includes a plurality of turns. The third winding portion has different axial distance between adjacent turns than the first winding portion and the second winding portion.

According to one aspect of the present disclosure, a signal transmission device, for cable television, includes one of the aforementioned inductor.

### BRIEF DESCRIPTION OF THE DRAWINGS

The present disclosure will become more fully understood from the detailed description given below and the accompanying drawings which are given by way of illustration only and thus are not intending to limit the present disclosure and wherein:

FIG. 1 is a schematic view of an inductor according to one embodiment of the present disclosure;

FIG. 2 is an exploded view of the inductor in FIG. 1;

FIG. 3 is a cross-sectional view of the inductor along line 3-3 in FIG. 1;

FIG. 4 is a cross-sectional view of the inductor along line 4-4 in FIG. 1;

FIG. 5 is a schematic view of the coil in FIG. 2;

FIG. 6 is a cross-sectional view of the magnetic core in FIG. 2; and

FIG. 7 is a schematic view showing use of the inductor in cable television according to one embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

A new generation of access network technology that can be called DOCSIS has been introduced for bi-directional CATV networks. By adopting a new efficient coding technique, increasing the deployment of modulation techniques with higher QAM (Quadrature Amplitude Modulation) modulation levels, and expanding the transmission bandwidth, the utilization efficiency and transmission capability of the physical spectrum resources of the bi-directional cable television network are greatly improved. However, a higher transmission bandwidth results in greater loss and is more susceptible to noise interference. Therefore, an inductor with magnetic core that supports high transmission bandwidth, has relatively low transmission loss, and has good Hum noise suppression capability is one of the issues that currently needs to be studied in this technical field.

According to the present disclosure, an inductor may include a magnetic core including a first magnetic portion and a second magnetic portion with different radial dimensions. A coil of the inductor may include two sections wound in an opposite manner. The coil may also include a third winding portion with fewer turns or larger turn spacing. Thus, it is helpful for adjusting the inductance of the inductor to meet different transmission bandwidth frequencies.

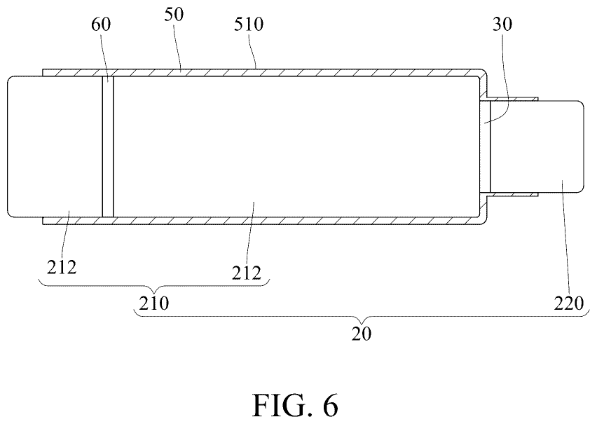

Furthermore, any of the first magnetic portion and the second magnetic portion may include multiple magnetic elements in series. For example, as shown in FIG. 6, the first magnetic portion 210 may include multiple magnetic elements 212 in series. An electrically insulating pad (e.g., the spacer 60 in FIG. 6) can be additionally disposed between adjacent magnetic elements of the first magnetic portion or the second magnetic portion so as to facilitate the adjustment of inductance to meet different transmission bandwidth frequencies and Hum noise suppression capability.

Unless otherwise specified, the terms “exemplary”, “example” and “embodiment” are used to indicate to indicate that they are merely examples or for illustrative purposes, and should not be interpreted as being preferred or advantageous. Unless otherwise specified, an embodiment or an example may indicate one or more embodiments or one or more examples. In addition, the term “may” can encompass all meanings of the term “can”.

Unless otherwise specified, similar symbols may represent similar objects, even though they may be depicted in different drawings. Unless otherwise specified, in one or more embodiments, the same elements (or elements with the same name) in different drawings may have the same or substantially the same function and properties. The names of the various elements used in the following description are chosen for illustration only, and therefore may be different from the names used in actual products.

The shapes (e.g., dimensions, lengths, widths, heights, thicknesses, positions, radii, diameters, and areas), scales, ratios, angles, quantities, etc. disclosed herein (including those depicted in the drawings) are merely exemplary, and therefore the present disclosure is not limited by the details depicted. The relative scales of the elements shown in the drawings may be within the scope of the present disclosure.

In cases where the terms “comprising”, “having”, “including”, “containing” are used with respect to one or more elements, unless terms such as “only”, “merely” are used, one or more other elements may be added. The terms used in the present disclosure are used only to describe embodiments, and are not intended to limit the scope of the present disclosure. Unless the context clearly indicates otherwise, the singular form of a term may include the plural form.

When describing spatial relationships of elements, unless clearly restrictive terms such as “directly”, “tightly” are used, one or more other elements may be positioned between any two elements.

Some terms may be used herein to describe the relationships between elements as depicted in the drawings, and it should be understood that these terms are spatial-related and based on the orientations depicted in the drawings.

The terms “first”, “second”, etc. may be used to describe multiple elements, but these elements should not be limited to any particular order, sequence or quantity by these terms. These terms are only used to distinguish one element from another element. For example, within the scope of the present disclosure, a first element may be referred to as a second element, and similarly, a second element may be referred to as a first element. Furthermore, within the scope of the present disclosure, the first element, the second element, etc. may be named arbitrarily by one having ordinary skill in this field to which the present disclosure pertains. For clarity, the functions or configuration of these element (e.g., the first element, the second element, etc.) are not limited by the preceding ordinal numbers or names. Furthermore, the first element may include one or more first elements. Similarly, the second element may include one or more second elements.

The term “or” indicates “inclusive or” rather than “exclusive or”. That is, unless otherwise specified or clearly understood from the context, the expression “A or B” naturally includes any combination. For example, the term “A or B” may encompass “A”, “B” or “A and B”. The term “A, B or C” may encompass “A”, “B”, “C”, “A and B”, “B and C”, “A and C” or “A, B and C”.

One or more features disclosed in one or more embodiments of the present disclosure may be combined to achieve the corresponding technical effects.

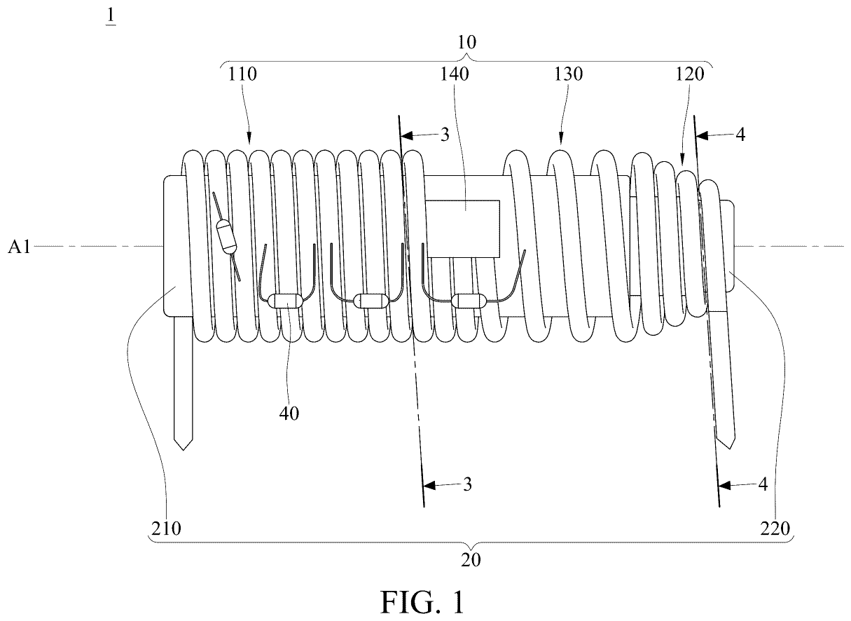

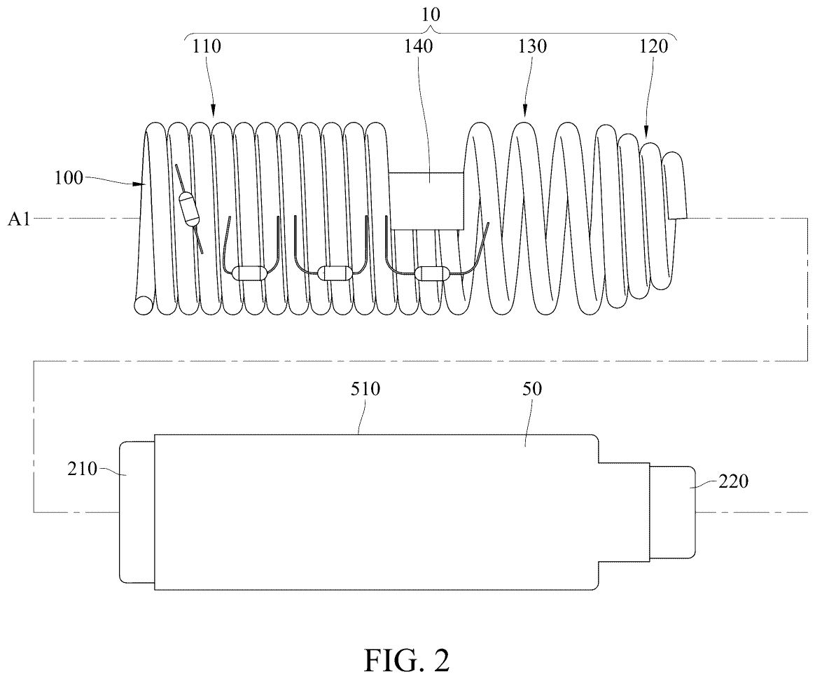

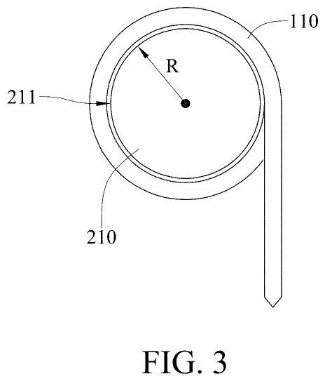

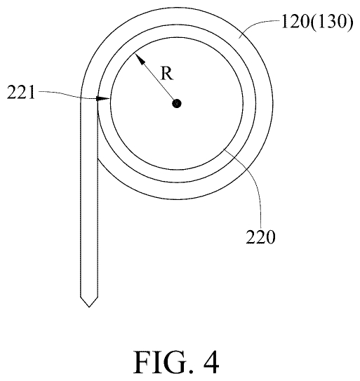

Please refer to FIG. 1 to FIG. 4. FIG. 1 is a schematic view of an inductor according to one embodiment of the present disclosure, FIG. 2 is an exploded view of the inductor in FIG. 1, FIG. 3 is a cross-sectional view of the inductor along line 3-3 in FIG. 1, and FIG. 4 is a cross-sectional view of the inductor along line 4-4 in FIG. 1. In this embodiment, an inductor 1 may include a coil 10 and a magnetic core 20. The coil 10 may have a cavity 100 which extends axially. The magnetic core 20 may be disposed through the cavity 100 and surrounded by the coil 10. The coil 10 may be made of conductive material such as copper, and the magnetic core 20 may be made of ferromagnetic material.

Herein, the terms “extend axially” encompass both straight and non-straight extension. Furthermore, the coil 10 and the magnetic core 20 are exemplarily depicted as extending straight, but the present disclosure is not limited thereto. In some embodiments, the coil and the magnetic core may extend axially in an arc shape to form a C-shape. In some embodiments, the coil and the magnetic core may extend axially and be bent to form a U-shape.

According to one embodiment of the present disclosure, the magnetic core may include a plurality of magnetic portions. Referring to FIG. 1 and FIG. 2, the magnetic core 20 may include a first magnetic portion 210 and a second magnetic portion 220. The first magnetic portion 210 and the second magnetic portion 220 may be arranged in the axial direction A1 of the coil 10. The first magnetic portion 210 and the second magnetic portion 220 may have different radial sizes. As shown in FIG. 2, the radial size of the first magnetic portion 210 may be larger than the radial size of the second magnetic portion 220. Furthermore, the cross-sectional area of the first magnetic portion 210 in the radial direction R (i.e., the area of the first magnetic portion 210 in FIG. 3) may be larger than the cross-sectional area of the second magnetic portion 220 in the radial direction R (i.e., the area of the second magnetic portion 220 in FIG. 4). In some embodiments, the magnetic core may further include additional third magnetic portion, and the radial size of the third magnetic portion may be different from the radial size of the first magnetic portion 210 and the radial size of the second magnetic portion 220.

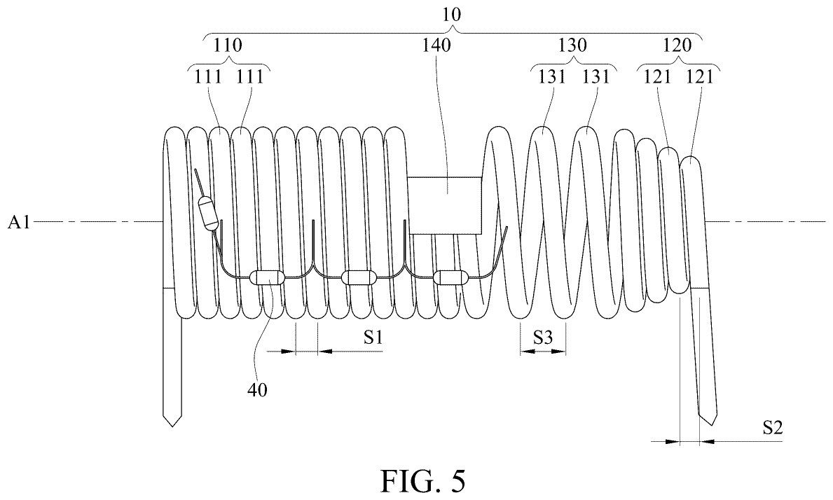

According to one embodiment of the present disclosure, the coil may include a first winding portion and second winding portion which are axially arranged. FIG. 5 is a schematic view of the coil in FIG. 2. The coil 10 may include a first winding portion 110 and a second winding portion 120 which are axially arranged. The first winding portion 110 may be wound counterclockwise around the magnetic core 20, and the second winding portion may be wound clockwise around the magnetic core 20. More specifically, referring to FIG. 3 and FIG. 4, the first winding portion 110 is wound counterclockwise around the periphery 211 of the first magnetic portion 210, and the second winding portion 120 is wound clockwise around the periphery 221 of the second magnetic portion 220, that is, the winding directions of the first winding portion 110 and the second winding portion 120 may be opposite. FIG. 3 and FIG. 4 exemplarily show the winding directions of the coil as viewed from the right side of the inductor 1. If viewed from the left side of the inductor 1, the first winding portion 110 may be wound clockwise, and the second winding portion 120 may be wound counterclockwise. The drawings exemplarily depict the coil 10 wound and spaced apart from the magnetic core 20, but the present disclosure is not limited thereto. In some embodiments, the coil may be wound and directly contact the magnetic core.

According to one embodiment of the present disclosure, the coil may further include a third winding portion. Referring to FIG. 1 and FIG. 5, may further include a third winding portion 130. The third winding portion 130 is disposed between the first winding portion 110 and the second winding portion 120. The first winding portion 110 may be connected to the second winding portion 120 through the third winding portion 130. The first winding portion 110 and the third winding portion 130 may be disposed corresponding to the first magnetic portion 210 of the magnetic core 20, and the second winding portion 120 may be disposed corresponding to the second magnetic portion 220. Furthermore, as shown in FIG. 4, the second winding portion 120 and the third winding portion 130 may be wound clockwise around the periphery 221 of the second magnetic portion 220.

The radial size of portions of the coil may correspond to the radial size of respective magnetic portions around which they are wound. Referring to FIG. 1, FIG. 3 and FIG. 4, the first winding portion 110 and the third winding portion 130 may be wound around the first magnetic portion 210, such that it can be interpreted that the first winding portion 110 and the third winding portion 130 correspond to a magnetic portion with a larger radial size. The second winding portion 120 may be wound around the second magnetic portion 220, such that it can be interpreted that the second winding portion 120 corresponds to a second magnetic portion with a smaller radial size. In such a case, the radial sizes of the first winding portion 110 and the third winding portion 130 may be larger than the radial size of the second winding portion 120. Said “corresponding radial size” may encompass identical radial size or slightly larger coil radial size. Specifically, a winding portion may have identical radial size to a corresponding magnetic portion such that the winding portion contacts a periphery of the corresponding magnetic portion. Alternatively, a winding portion may have slightly larger radial size than a corresponding magnetic portion such that the winding portion is spaced apart from the periphery of the corresponding magnetic portion for facilitating the operation of extending or compressing this winding portion.

According to one embodiment of the present disclosure, the third winding portion may have different axial distance between adjacent turns than the first winding portion. Referring to FIG. 1 and FIG. 5, the first winding portion 110 may include a plurality of turns 111, the second winding portion 120 may include a plurality of turns 121, and the third winding portion 130 may include a plurality of turns 131. An axial distance between adjacent turns may refer to the spacing between adjacent turns in the axial direction A1 of the coil 10. As shown in FIG. 5, the spacing S3 between adjacent turns 131 may be larger than the spacing S1 between adjacent turns 111, and the spacing S3 between adjacent turns 131 may be also larger than the spacing S2 between adjacent turns 121. The drawings exemplarily depict that the turns of the first winding portion 110 and the second winding portion 120 are tightly arranged, such that the spacing S1 may be substantially equal to the thickness of single turn 111 in the axial direction A1, and the spacing S2 may be substantially equal to the thickness of single turn 121 in the axial direction A1. The larger spacing S3 of the third winding portion 130 may be achieved by providing fewer turns than the first winding portion 110 or the second winding portion 120. In some other embodiments, the spacing S3 may be smaller than the spacing S2. In some other embodiments, the spacing S3 may be smaller than the spacing S1.

According to one embodiment of the present disclosure, the coil may further include a bonding pad. Referring to FIG. 1 and FIG. 5, the coil 10 may further include a bonding pad 140. The first winding portion 110 may be connected to the third winding portion 130 through the bonding pad 140, and the third winding portion 130 may be connected to the second winding portion 120. The bonding pad 140 may be disposed corresponding to the first magnetic portion 210 of the magnetic core 20. Furthermore, one end of the first winding portion 110 and that of the third winding portion 130 may be soldered to the bonding pad 140.

According to one embodiment of the present disclosure, the second magnetic portion may be glued to one end of the first magnetic portion. FIG. 6 is a cross-sectional view of the magnetic core in FIG. 2. As shown in FIG. 1 and FIG. 6, the inductor 1 may further include a spacer 30 disposed between the first magnetic portion 210 and the second magnetic portion 220. The spacer 30 may be a plastic pad with adhesion, and the second magnetic portion 220 may be glued to the first magnetic portion 210 through the spacer 30.

According to one embodiment of the present disclosure the inductor may further include a plurality of resistors in parallel. Referring to FIG. 1 and FIG. 5, the inductor 1 may further include a plurality of resistors 40 in parallel. Each of the resistors 40 may include electronic color code and is electrically connected to any two turns of the coil 10. As shown in FIG. 5, one of the resistors 40 may be electrically connected to two turns 111 of the first winding portion 110, and another resistor 40 may be electrically connected to one turn 111 of the first winding portion 110 and one turn 131 of the third winding portion 130. Each resistor 40 may be electrically connected to adjacent turns or non-adjacent turns of the coil. The drawings exemplarily depict the arrangement of resistors 40 on the coil 10 without showing their specific terminals.

According to one embodiment of the present disclosure, the inductor may further include a sleeve. Referring to FIG. 1, FIG. 2 and FIG. 6, the inductor 1 may further include a sleeve 50. The first magnetic portion 210 and the second magnetic portion 220 of the magnetic core 20 may be disposed in the sleeve 50, and the coil 10 may be wound on the outer surface 510 of the sleeve 50. Furthermore, the coil 10 may directly contact the outer surface 510.

According to one embodiment of the present disclosure, the inductor may further include a spacer. Referring to FIG. 1 and FIG. 6, the inductor 1 may further include a spacer 60. The first magnetic portion 210 of the magnetic core 20 may include a plurality of magnetic elements 212 arranged in the axial direction of the coil 10. The magnetic elements 212 may have substantially the same radial size, and the spacer 60 may be disposed between any adjacent two of the magnetic elements 212.

According to one embodiment of the present disclosure, the magnetic core 20 may include the first magnetic portion 210 and the second magnetic portion 220, and the first magnetic portion 210 and the second magnetic portion 220 may have different radial sizes. By multiple magnetic portions with different radial sizes in series, the magnetic portions with different magnetic fluxes can be combined for use, which facilitates the adjustment of inductance.

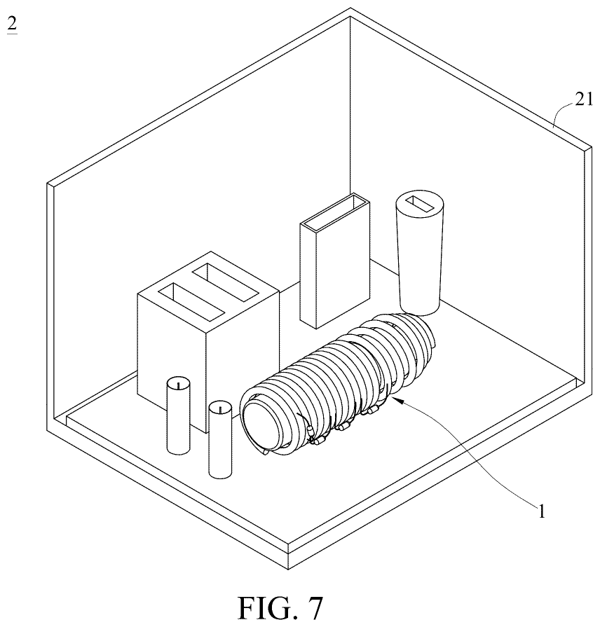

The inductor of the present disclosure may be applied to CATV industry. FIG. 7 is a schematic view showing use of the inductor in cable television according to one embodiment of the present disclosure. A signal transmission device 2 for CATV network system may be an electronic device for hybrid fiber-coaxial (HFC) network or a TV set-top box. More specifically, the signal transmission device 2 may be a system amplifier or a line extender amplifier. The signal transmission device 2 may include a housing 21, a radio frequency (RF) module or a power supply module may be inside the housing 21. The RF module or the power supply module may include one or more components or circuits, and said one or more components may include any one of the inductors disclosed in the aforementioned embodiments. FIG. 7 exemplarily depicts that the one or more components include the inductor 1 as shown in FIG. 1. In some embodiments, an encapsulation may be additionally provided to cover the inductor 1, and the encapsulation may be, for example but not limited to, a dual in-line package (DIP) structure or a surface mount device (SMD) package structure. The encapsulation may be flexibly selected according to the specifications of the signal transmission device 2 for CATV network system.

According to the inductor 1 in FIG. 1 and the signal transmission device 2 disclosed in this embodiment, the magnetic core 20 of the inductor 1 may include the first magnetic portion 210 and the second magnetic portion 220 with different radial sizes. The combination of magnetic portions with different radial sizes is favorable for adjusting the inductance to meet different transmission bandwidth frequencies. For example, when the inductor 1 is applied to products with different transmission bandwidth frequency specifications, the manufacturers can conveniently adjust the inductance of the inductor 1 according to the product specifications. Moreover, the inductance of the inductor 1 can be adjusted by varying the number of turns in a unit length of the coil 10 can be adjusted (e.g., increasing or decreasing the spacing of adjacent turns 131 of the third winding portion 130); or, the inductance of the inductor 1 can be adjusted by making more turns of coil 10 correspond to the first magnetic portion 210 with larger radial size (e.g., moving some turns 121 of the second winding portion 120 to a region corresponding to the first magnetic portion 210).

According to the inductor 1 in FIG. 1 and the signal transmission device 2 disclosed in this embodiment, the first winding portion 110 may be wound clockwise, and the second winding portion 120 may be wound counterclockwise. By setting two coil portions wound in an opposite manner, it is favorable for reducing Hum noise and preventing any problems due to noise suppression at high transmission bandwidth frequencies.

According to the inductor 1 in FIG. 1 and the signal transmission device 2 disclosed in this embodiment, the axial distance between adjacent turns 131 of the third winding portion 130 may be different from the axial distance between adjacent turns 111 of the first winding portion 110. Therefore, it is favorable for fine-tuning the inductance to meet high-frequency characteristics.

According to the inductor 1 in FIG. 1 and the signal transmission device 2 disclosed in this embodiment, the resistors 40 are connected in parallel and electrically connected to the coil 10. Therefore, it is favorable for filtering out high-frequency resonance, thereby improving high-bandwidth transmission performance.

The embodiments are chosen and described in order to best explain the principles of the present disclosure and its practical applications, to thereby enable others skilled in the art to best utilize the present disclosure and various embodiments with various modifications as are suited to the particular use being contemplated. It is intended that the scope of the present disclosure is defined by the following claims and their equivalents.

What is claimed is:

1. An inductor, comprising:
a coil having a cavity which extends axially; and
a magnetic core disposed through the cavity;
wherein the magnetic core comprises a first magnetic portion and a second magnetic portion, the first magnetic portion and the second magnetic portion are arranged in an axial direction of the coil, and the first magnetic portion and the second magnetic portion have different radial sizes.

2. The inductor according to claim 1, wherein the coil comprises a first winding portion and a second winding portion which are arranged axially, the first winding portion is wound counterclockwise around the first magnetic portion, and the second winding portion is wound clockwise around the second magnetic portion.

3. The inductor according to claim 2, wherein the coil further comprises a bonding pad and a third winding portion, the third winding portion is disposed between the first winding portion and the second winding portion, the first winding portion is connected to the third winding portion through the bonding pad, and the third winding portion is connected to the second winding portion.

4. The inductor according to claim 3, wherein each of the first winding portion and the third winding portion comprises a plurality of turns, and the third winding portion has different axial distance between adjacent turns than the first winding portion.

5. The inductor according to claim 4, wherein the first magnetic portion has larger radial size than the second magnetic portion, the first winding portion, the bonding pad and the third winding portion are disposed corresponding to the first magnetic portion, and the second winding portion is disposed corresponding to the second magnetic portion.

6. The inductor according to claim 1, wherein the second magnetic portion is glued to an end of the first magnetic portion.

7. The inductor according to claim 1, further comprising a plurality of resistors in parallel, wherein each of the plurality of resistors is electrically connected to any two turns of the coil.

8. The inductor according to claim 1, further comprising a sleeve, wherein the first magnetic portion and the second magnetic portion of the magnetic core are disposed in the sleeve, and the coil is wound on an outer surface of the sleeve.

9. The inductor according to claim 1, further comprising a spacer, wherein the first magnetic portion includes a plurality of magnetic elements arranged in the axial direction of the coil, and the spacer is disposed between any adjacent two of the plurality of magnetic elements.

10. The inductor according to claim 1, further comprising a spacer disposed between the first magnetic portion and the second magnetic portion.

11. An inductor, comprising:
a coil having a cavity which extends axially; and
a magnetic core disposed through the cavity;
wherein the coil comprises a first winding portion and a second winding portion which are arranged axially, the first winding portion is connected to the second winding portion, the first winding portion is wound counterclockwise around the magnetic core, and the second winding portion is wound clockwise around the magnetic core.

12. The inductor according to claim 11, wherein the coil further comprises a bonding pad and a third winding portion, the third winding portion is disposed between the first winding portion and the second winding portion, the first winding portion is connected to the third winding portion through the bonding pad, and the third winding portion is connected to the second winding portion.

13. The inductor according to claim 12, wherein each of the first winding portion and the third winding portion comprises a plurality of turns, and the third winding portion has different axial distance between adjacent turns than the first winding portion.

14. The inductor according to claim 11, further comprising a sleeve, wherein the magnetic core is disposed in the sleeve, and the coil is wound on an outer surface of the sleeve.

15. The inductor according to claim 11, further comprising a spacer, wherein the magnetic core includes a plurality of magnetic elements arranged in the axial direction of the coil, and the spacer is disposed between any adjacent two of the plurality of magnetic elements.

16. An inductor, comprising:
a coil having a cavity which extends axially; and
a magnetic core disposed through the cavity;
wherein the coil comprises a first winding portion, a second winding portion and a third winding portion arranged in an axial direction of the coil, the third winding portion is disposed between the first winding portion and the second winding portion, the first winding portion is connected to the second winding portion through the third winding portion, each of the first winding portion, the second winding portion and the third winding portion comprises a plurality of turns, and the third winding portion has different axial distance between adjacent turns than the first winding portion and the second winding portion.

17. The inductor according to claim 16, wherein the first winding portion is wound counterclockwise around the magnetic core, and the second winding portion is wound clockwise around the magnetic core.

18. A signal transmission device for cable television, comprising the inductor according to claim 1.

19. A signal transmission device for cable television, comprising the inductor according to claim 11.

20. A signal transmission device for cable television, comprising the inductor according to claim 16.
